(19) United States
(12) Patent Application Publication
(10) Pub. No.: US 2003/0061764 A1
(43) Pub. Date: Apr. 3, 2003

(54) Method and apparatus for steam reforming of hydrocarbons

(76) Inventors: Belhocine Benallal, Greenfield Park (CA); David Elkaim, St-Laurent (CA); Kyle Valdock, Mississauga (CA); Normand Brais, Rosemere (CA); Debbie Soriano, Montreal (CA); Louis-Michel Malouin, Montreal (CA)

Correspondence Address: OGILVY RENAULT, 1981 MCGILL COLLEGE AVENUE, SUITE 1600, MONTREAL, QC, H3A2Y3, CA

(21) Appl. No.: 09/967,526

(22) Filed: Oct. 1, 2001

(51) Int. Cl. C01B 3/32

(52) U.S. Cl. 48/198.7; 48/127.9; 422/198; 422/200; 422/202; 422/211

(57) ABSTRACT

An apparatus for steam reforming of hydrocarbons, the apparatus comprising a vessel defining a combustion chamber. The combustion chamber has a burner device for combustion of a fuel and a flue gas outlet for exhausting flue gas resulting from the combustion. A second chamber is integrally formed with the vessel. The second chamber comprises a first inlet conduit adapted for receiving water therein and an outlet conduit for exhausting steam. A reformer tube in the combustion chamber is filled with a catalyst and is connected to a second inlet conduit for having a steam and hydrocarbon mixture flow therethrough, and to a second outlet conduit for exhausting a process gas resulting from a steam reforming process in the reformer tube. The reformer tube is disposed in the combustion chamber so as to transfer heat from the combustion to the steam reforming process. Flue gas from the combustion chamber and process gas from the reformer tube are used for transferring heat to the water in the second chamber so as to produce steam to be used for the steam reforming process.

### FIELD OF THE INVENTION

The present invention generally relates to fuel cell systems and, more particularly, to an apparatus for the production of hydrogen by steam reforming for fuel cells.

### BACKGROUND OF THE INVENTION

Amongst energy storage systems, fuel cell systems combine a plurality of characteristics which enables them to be used in a variety of applications. For instance, fuel cell systems represent a portable, mobile and independent source of energy, which may advantageously be used in remote locations not covered by grid power sources. Furthermore, fuel cells are odor and pollution free, and operate quietly.

In a fuel cell, heat and electricity are produced by way of an electrochemical reaction between a fuel, such as hydrogen, and oxygen. The fuel cell typically comprise two catalyst-coated electrodes (i.e. anode and cathode), which are separated by a polymer electrolyte membrane. The hydrogen fuel is fed to the anode, whereas oxygen enters through the cathode. In the presence of the catalyst, the hydrogen molecules split in two protons and two electrons. The electrons resulting from the split will flow through an external circuit, whereby electrical current is created. On the other hand, protons produced by the hydrogen molecule are transferred through the polymer electrolyte membrane and combine at the cathode with the electrons and oxygen from the air to form water and generate heat.

Various methods have been provided in order to generate hydrogen to be used with the fuel cells. One such method is the steam reforming of hydrocarbon mixtures which consists in a chemical process in which steam and hydrocarbons react to produce hydrogen, as well as carbon monoxide, carbon dioxide and methane. This chemical process takes place in a steam reformer, when a mixture of steam and hydrocarbons are subject to high temperatures while flowing through a catalyst filled zone. Steam reforming is a highly endothermic process as the chemical reaction absorbs heat, and thus steam reformers are often supplied with combustion systems for producing the necessary thermal energy required in the chemical process.

U.S. Pat. No. 4,861,347, issued on Aug. 29, 1989 to Szydlowski et al. discloses a compact steam reformer which is defined by a cylindrical vessel enclosing a reforming section and a combustion chamber. The combustion chamber is of cylindrical shape and is concentrically positioned within the steam reformer. The combustion chamber has fuel and air intakes at a top end thereof. The reforming section is an annular chamber surrounding the cylindrical combustion chamber. The flue gas resulting from the combustion of the fuel will flow from the combustion chamber to the bottom of the cylindrical vessel. It then moves up and circulates around the annular reforming section and through passages therein, whereby heat is absorbed by the chemical reaction taking place in the reforming section. The steam reforming section is closed from the combustion chamber and is filled with a catalyst, and the steam and hydrocarbons mixture injected in the reforming section reacts in the presence of the catalyst as it flows therethrough while absorbing heat from the flue gas of the combustion chamber to produce hydrogen and carbon monoxides.

Although fuel cells provide a highly efficient power source, the production of hydrogen for use therewith involves energy consumption for supplying heat to the endothermic reaction, for producing steam to be mixed with the hydrocarbons. In order to render the production of hydrogen efficient, it would be desirable to minimize the energy consumed in the production of the hydrogen. Accordingly, it would be desirable to provide a highly integrated steam reformer, that is to say a steam reformer maximizing the recuperation of the heat produced to supply the endothermic reaction of steam reforming. Furthermore, steam reformers are often associated with other systems, such as boilers for steam production, pre-heaters to bring the process gases up to a given temperature level.

### SUMMARY OF THE INVENTION

It is a feature of the present invention to provide a steam reformer which minimizes its consumption of energy.

It is a further feature of the invention to provide a steam reformer which is compact.

It is a still further feature of the present invention to provide a steam reformer recuperating unused hydrogen from fuel cells.

It is a still further feature of the present invention to provide a steam reformer which is capable of producing its own steam for use in its steam reforming process.

According to the above feature of the present invention, from a broad aspect, the present invention provides an apparatus for steam reforming of hydrocarbons. The apparatus comprises a vessel defining a combustion chamber. The combustion chamber has a burner device for combustion of a fuel and a flue gas outlet for exhausting flue gas resulting from the combustion. A second chamber is integrally formed with the vessel. The second chamber comprises a first inlet conduit adapted for receiving water therein and an outlet conduit for exhausting steam. A reformer tube in the combustion chamber is filled with a catalyst and is connected to a second inlet conduit for having a steam and hydrocarbon mixture flow therethrough, and to a second outlet conduit for exhausting a process gas resulting from a steam reforming process in the reformer tube. The reformer tube is disposed in the combustion chamber so as to transfer heat from the combustion to the steam reforming process. Flue gas from the combustion chamber and process gas from the reformer tube are used for transferring heat to the water in the second chamber so as to produce steam to be used for the steam reforming process.

According to a further broad aspect of the present invention there is provided a method for steam reforming of hydrocarbons, comprising the steps of (i) feeding a steam and hydrocarbon mixture of a predetermined ratio to an inlet of a steam reforming apparatus; (ii) pre-heating the steam and hydrocarbon mixture by supplying a flow of the steam and hydrocarbon mixture in a pre-heating conduit in a combustion chamber of the apparatus wherein combustion of fuel occurs; (iii) producing a steam reformed process gas with the steam and hydrocarbon mixture by supplying a flow of the steam and hydrocarbon mixture to a reformer tube filled with a catalyst and disposed in the combustion chamber to absorb heat from the combustion; and (iv) producing steam for the step (i) by recuperating heat from flue gas from the combustion, by circulating the hot flue gas through a second chamber of the apparatus in heat exchange relation with a water-containing third chamber of the apparatus.

### BRIEF DESCRIPTION OF THE DRAWINGS

A preferred embodiment of the present invention will now be described in detail having reference to the accompanying drawings in which:

FIG. 1 is a front elevational view of the steam reformer in accordance with the present invention;

FIG. 2 is a front elevational cross sectional view of a boiler section of the steam reformer;

FIG. 3 is a top perspective view of a reformer section of the steam reformer;

FIG. 4 is a bottom perspective view of the reformer section; and

FIG. 5 is a front elevational cross sectional view of an injector of the steam reformer.

### DESCRIPTION OF PREFERRED EMBODIMENTS

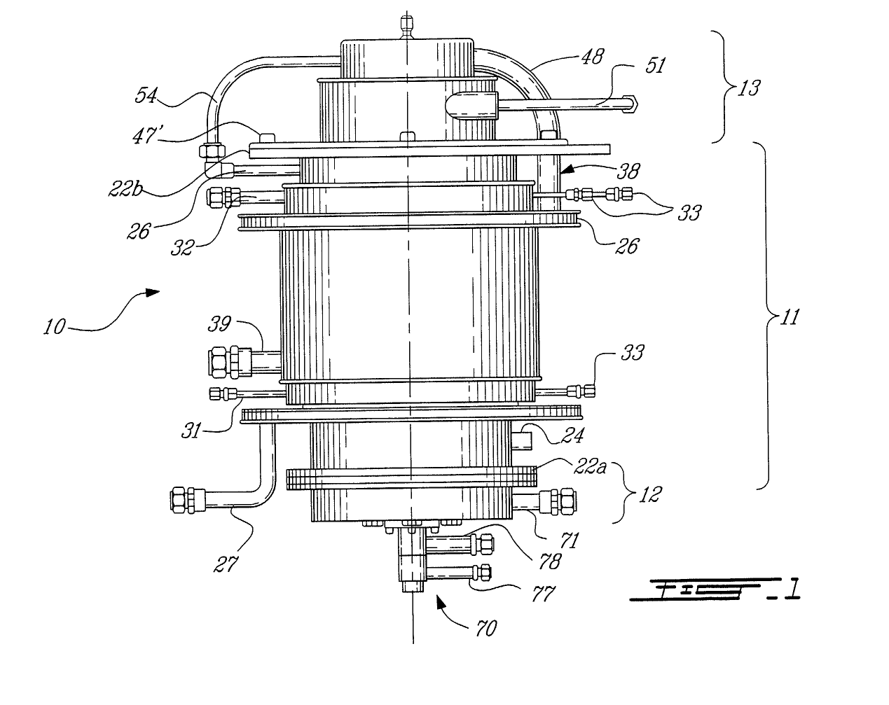

According to the drawings and more particularly to FIG. 1, a steam reformer in accordance with the present invention is generally shown at 10. The steam reformer 10 comprises a boiler section 11, a combustor section 12 and a reformer section 13.

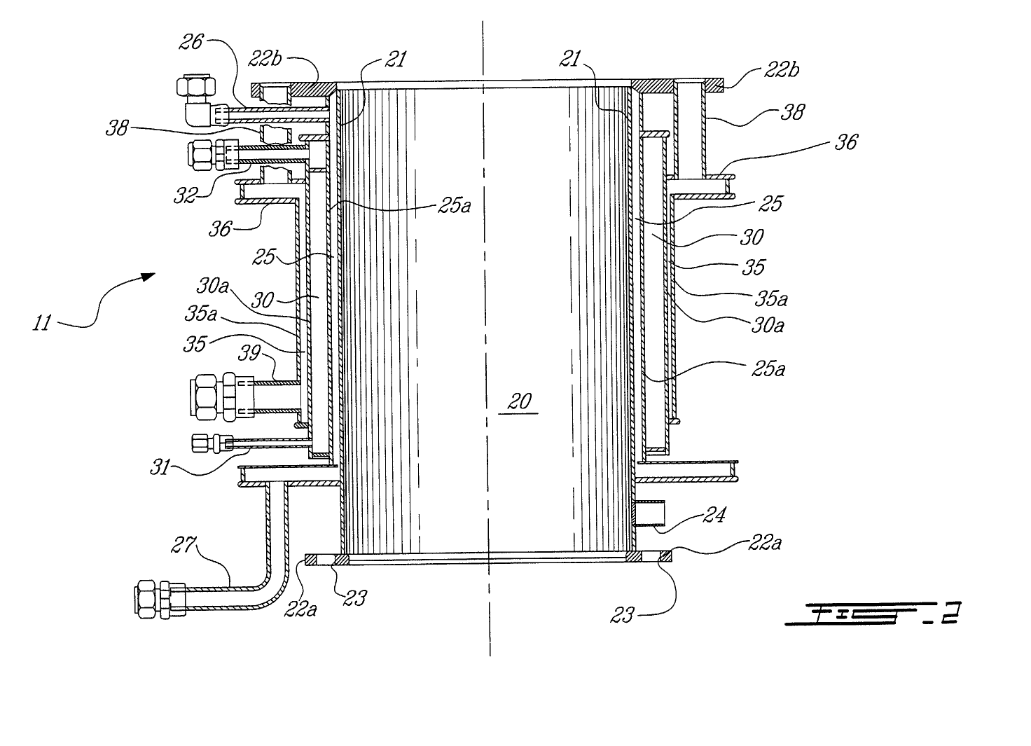

Referring to both FIGS. 1 and 2, the boiler section 11 is shown having a generally cylindrical body defining an inner combustion chamber 20. The combustion chamber 20 is bounded by a cylindrical wall 21. A first flange 22a projects outwardly from the bottom of the cylindrical wall 21. The first flange 22a is adapted for securing the combustor section 12 to the boiler section 11, and thus has a plurality of throughbores 23 circumferentially disposed thereon to accommodate fastening bolts. A second flange 22b projects outwardly from the top end of the cylindrical wall 21 so as to connect the boiler section 11 to the reformer section 13 once more through a plurality of throughbores to accommodate fastening bolts (not shown). The boiler section 11 further comprises a sight tube 24 equipped with a see-through wall for an operator to look inside the steam reformer 10.

A process gas hollow cylindrical jacket 25 is defined by a process gas sleeve 25a spaced from and surrounding the cylindrical wall 21 of the boiler section 11. The process gas hollow cylindrical jacket 25 has at a top end thereof a process gas inlet 26, and at a bottom thereof a process gas outlet 27. Another sleeve 30a is spaced from and surrounds the process gas sleeve 25a to form a steam hollow cylindrical jacket 30. The steam jacket 30 has a water inlet 31 at a bottom thereof and a steam outlet 32 at a top end thereof. The steam jacket 30 is sandwiched between the process gas sleeve 25 and a flue gas jacket 35. The flue gas jacket 35 is defined by still another sleeve 35a, and has an annular chamber 36 projecting outwardly from a top end thereof. The annular chamber 36 is connected to the flange 22b of the cylindrical wall 21 through a plurality of flue gas conduits 38. Consequently, flue gas injected in the flue gas conduits 38 flows through the annular chamber 36 to reach the flue gas jacket 35. The flue gas jacket 35 has a flue gas outlet 39 at a bottom end thereof.

The sleeves 25a, 30a and 35a defining the above described jackets are of material adapted for facilitating the heat transfer therebetween. The object of these jackets is to transfer heat from flue gas flowing in the flue gas jacket 35, and from process gas flowing through the process gas jacket 25, to water contained in the steam jacket 30, whereby the water will be heated to produce steam at its steam outlet 32. On the other hand, the cylindrical wall 21 separating the combustion chamber 20 from the process gas jacket 25 is insulated so as to keep heat within the combustion chamber 20. This heat will be absorbed by the steam reforming reaction, as will be explained hereinafter. It is pointed out that the above described inlets and outlets are each adapted to be connected to various piping. As shown, a plurality of hexagonal-nut connectors are depicted mounted to the various inlets and outlets of the boiler section 11. Other fastening devices may be used, provided that the connections are leak-tight.

As steam is produced in the steam jacket 30, the latter is appropriately provided with various ports adapted for connection to various devices required for maintenance and safety during steam production. The ports are illustrated at 33 and are used for connecting relief valves, surface blow-downs, level controllers and the like to the steam jacket 30.

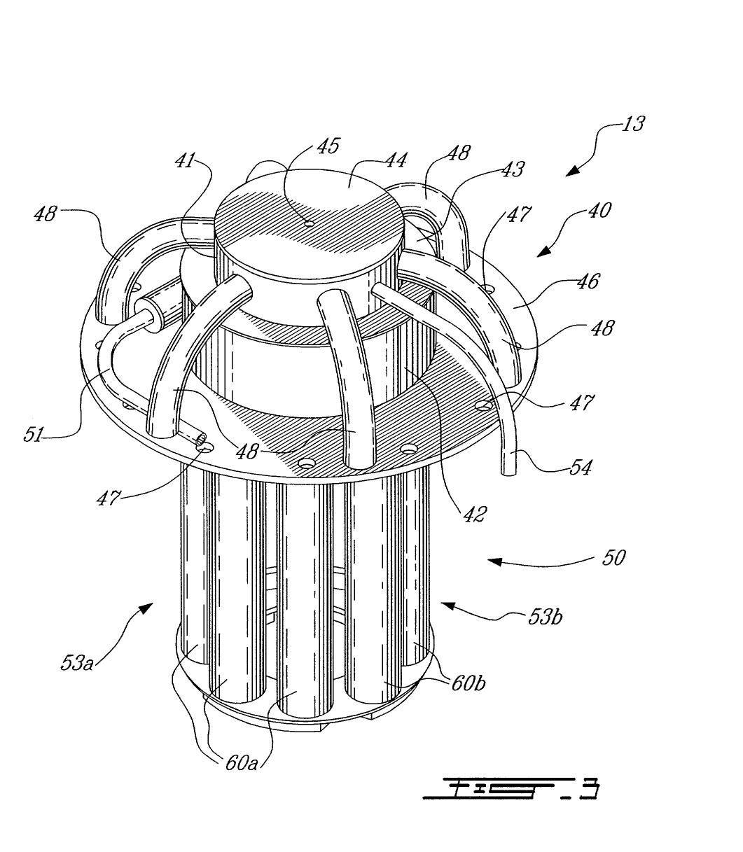

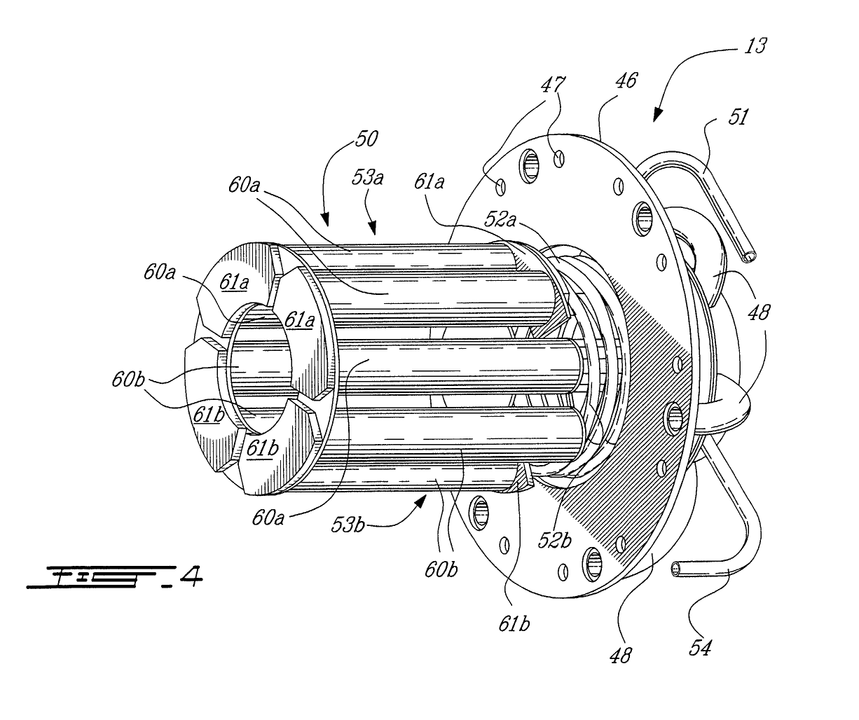

Referring now to FIGS. 3 and 4, the reformer section 13 is shown removed from the top end of the boiler section 11. The reformer section 13 comprises a head portion 40. The head portion 40 is defined by a first cylindrical wall 41 concentrically disposed on a second cylindrical wall 42 of larger diameter. An annular flat disc 43 joins a bottom edge of the first cylindrical wall 41 to a top edge of the second cylindrical wall 42. A circular cap 44 is secured to a top edge of first cylindrical wall 41. The circular cap 44 has a throughbore 45 therein for receiving temperature or combustion control devices therein, such as a thermocouple. It is pointed out that the combustion chamber 20 partly defined by the boiler section 11 is closed off on a top end thereof by the head portion 40.

The head portion 40 further comprises a circumferential flange 46 extending outwardly from a bottom end of the second cylindrical wall 42. The flange 46 is adapted for being secured to the flange 22b of the boiler section 11, by having a plurality of throughbores 47 circumferentially disposed on the flange 46, so as to be aligned with throughbores on the flange 22b of the boiler section 11 to accommodate bolt fasteners 47′ (see FIG. 1). A plurality of outlet pipes 48 extend from the first cylindrical wall 41 to a top surface of the flange 46. The outlet pipes extend through the first cylindrical wall 41, so as to provide an outlet for combustion gas reaching the head portion 40, as will be explained hereinafter. When the reformer section 13 is secured to the boiler section 11, the outlet pipes 48 will be aligned with the flue gas conduits 38. Flue gas from the combustion chamber 20 accumulating in the head portion 40, and more particularly, within the hollow cavity defined by the first cylindrical wall 41 and the circular cap 44, will exit the head portion 40 through the outlet pipes 48 to reach the flue gas conduit 38, and then the annular chamber 36 and the flue gas jacket 35.

The reformer section 13 further comprises a reformer tube section 50. The reformer tube section 50 has a steam/hydrocarbon inlet 51, pre-heater coils 52a and 52b, reformer tube series 53a and 53b, and a process gas outlet pipe 54. The steam-hydrocarbon inlet 51 extends through the second cylindrical wall 42, and diverges into the pre-heater coils 52a and 52b, which connect to the reformer tube series 53a and 53b, respectively. When the reformer section 13 is secured to the boiler section 11, the pre-heater coils 52a and 52b, and the reformer tube series 53a and 53b are in the combustion chamber 20, whereby they are exposed to heat resulting from combustion taking place therein. The steam/hydrocarbon mixture, prior to reaching the reformer tube series 53a and 53b, flows through the pre-heater coils 52a and 52b, in order to have its temperature raised in view of the steam reforming process in the reformer tube series 53a and 53b. As the steam reformer 10 of the present invention is highly integrated in order to minimize its energy consumption, the pre-heater coils 52a and 52b are preferably in the combustion chamber 20 to recuperate heat from the flue gas. However, the steam/hydrocarbon mixture may also be pre-heated remotely from the steam reformer 10.

The reformer tube series 53a and 53b are similar in configuration, and thus, only reformer tube series 53a will be described herein. Thereafter and in the figures, like numerals affixed with a letter “b” will designate similar members of the reformer tube series 53b. The reformer tube series 53a has four reformer tubes 60a, each filled with a catalyst. The catalyst is disposed in the tubes so as to allow the flow of a gas therethrough. For instance, wheel shaped elements of nickel-potassium may be provided in each reformer tube 60a. The four reformer tubes 60a are connected in series by junction plates 61a, which are configured to allow the flow of the gas between the reformer tubes 60a. The reformer tubes 60a are made of material enabling efficient heat exchange as the steam reforming reaction is endothermic and thus absorbs heat. The reformer tube series 53a and 53b merge to the process gas outlet pipe 54, which emerges through the first cylindrical wall 41 of the head portion 40.

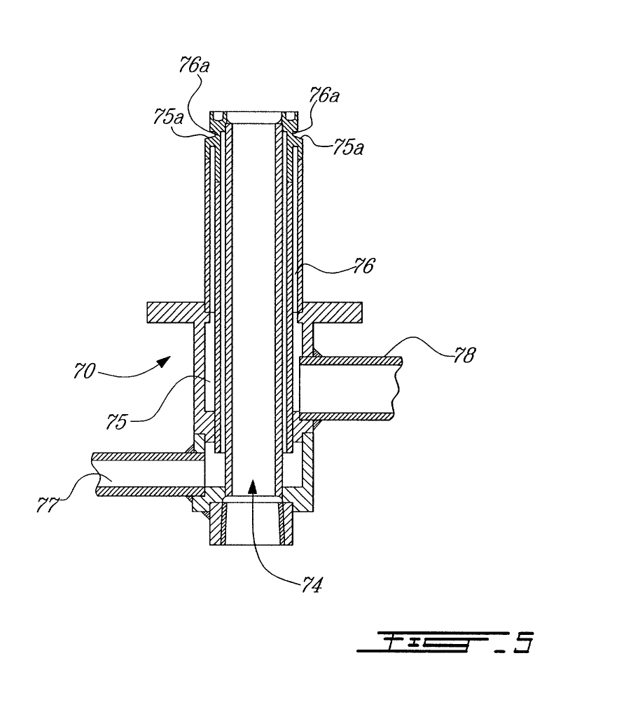

Referring now to FIGS. 1 and 5, the combustor section 12 is shown comprising an injector 70 and a combustion air inlet 71. The injector 70 is concentrically disposed at a bottom end of the combustor section 12. The combustor section 12 defines a hollow cup shape, with the combustion air inlet 71 entering through a lateral wall thereof. The injector 70 defines a passage 74 in which a flame igniter (not shown) is inserted. The injector 70 also has a pair of concentrically disposed cylindrical chambers 75 and 76 defined between cylindrical sleeves, each having an inlet 77 and 78, respectively. When the combustor section 12 is secured to the boiler section 11, the sleeves 75 and 76 are open to the combustion chamber 20 by injection holes 75a and 76a, respectively. Consequently, combustion fuel is be supplied to the inlets 77 and 78 so as to be injected in the combustion chamber and burnt in combination with air injected through the combustion air inlet 71. It is pointed out that two cylindrical chambers, 75 and 76, are provided so as to recuperate anode-off gas containing hydrogen from a fuel cell. The anode-off gas is a mixture of hydrogen, carbon dioxide, nitrogen and methane, residual from a fuel cell.

During the operation of the steam reformer 10, combustion takes place in the combustion chamber 20. This will provide the reformer tubes series 53a and 53b with the necessary heat for the endothermic chemical reaction of steam reforming, as will be described below. The inlets and outlets of the steam reformer 10 described above are each controlled by an appropriate control system, including various types of valves. For instance, specific ratios of steam and hydrocarbon (e.g. steam/carbon ratio of 3.0 to 3.5) must be fed to the steam reforming process in order to optimize the hydrogen output. Furthermore, ranges of temperature must be attained in the combustion chamber 20, Thus, the steam reformer 10 has its inlets and outlets modulated so as to obtain given results.

A steam/hydrocarbon mixture is injected in the steam/hydrocarbon inlet 51 of the reformer section 13 to be pre-heated in either one of the pre-heater coils 52a and 52b, which are subject to the heat from the combustion. It is pointed out that the hydrocarbons usually contain sulfur compounds and other impurities, wherefore they go through a desulfurization stage before they are mixed with steam through a mixing valve (not shown). The pre-heated steam/hydrocarbon mixture then reaches the reformer tube series 53a and 53b to undergo the chemical reaction by coming in contact with the heated catalyst within the reformer tubes 60a and 60b, while absorbing heat from the combustion chamber 20. The resulting process gas exits the reformer section 13 by the outlet pipe 54. This process gas will comprise hydrogen, methane, carbon dioxide and carbon monoxide, and water vapor. The process gas will go through a carbon monoxide clean up stage prior to being fed to the fuel cell in order to minimize its carbon monoxide contents and to add additional hydrogen.

The present invention now provides the opportunity to recuperate heat from the combustion and from the high temperature of the resulting process gas. In the first case, the flue gas from the combustion exits through the head portion 40 of the reformer section 13, as described above. The flue gas then flows through the flue gas outlet pipes 48 to reach the flue gas jacket 35. Consequently, heat exchange may occur between the flue gas in the flue gas jacket 35 and water in the steam jacket 30, whereby the water is heated. This allows for heat transfer to recuperate the heat from the flue gas.

The process gas from the reformer section 13 is conveyed through the process gas outlet pipe 54 to the process gas jacket 25 through the process gas inlet 26. Once more, the water in the steam jacket 30 is heated by the high temperature process gas flowing through the process gas jacket 25, and thus, steam is produced and exits through the steam outlet 32.

Thus, the architecture of these three concentric shells forming the above described jackets provides a very compact and energy efficient steam reformer creating its own steam. The steam emerging from the steam outlet 32 is then mixed through a valve with hydrocarbons such as natural gas or propane in order to then be injected in the reformer tube series 53a and 53b through the steam/hydrocarbon inlet 47.

It is within the ambit of the present invention to cover any obvious modifications of the embodiments described herein, provided such modifications fall within the scope of the appended claims.

1. An apparatus for steam reforming of hydrocarbons, said apparatus comprising:
a vessel defining a combustion chamber, said combustion chamber having a burner device for combustion of a fuel and a flue gas outlet for exhausting flue gas resulting from the combustion;
at least a second chamber integrally formed with said vessel, said second chamber comprising at least a first inlet conduit adapted for receiving water therein and at least an outlet conduit for exhausting steam; and
at least a reformer tube in said combustion chamber; said reformer tube being filled with at least one catalyst and being connected to a second inlet conduit for having a steam and hydrocarbon mixture flow therethrough, and to a second outlet conduit for exhausting a process gas resulting from a steam reforming process in said reformer tube, said reformer tube being disposed in said combustion chamber so as to transfer heat from the combustion to said steam reforming process;
wherein at least one of said flue gas from said combustion chamber and said process gas from said reformer tube is used for transferring heat to the water in said second chamber so as to produce steam to be used for said steam reforming process.

2. The apparatus according to claim 1, wherein said second chamber is a hollow cylindrical jacket surrounding a portion of said vessel.

3. The apparatus according to claim 2, wherein said second chamber shares a wall with a third chamber receiving said flue gas exhausting from said combustion chamber through said flue gas outlet, for heat transfer from the flue gas in said third chamber to the water in said second chamber.

4. The apparatus according to claim 3, wherein said second chamber shares another wall with a fourth chamber receiving said process gas exiting from said reformer tube through said outlet conduit, for heat transfer from the process gas in said fourth chamber to the water in said second chamber.

5. The apparatus according to claim 4, wherein said second chamber is sandwiched between said third chamber and said fourth chamber, said third and fourth chambers each being hollow cylindrical jackets.

6. The apparatus according to claim 1, wherein the fuel burnt by said burner device includes anode off-gas containing hydrogen recuperated from fuel cells.

7. The apparatus according to claim 1, further comprising a plurality of reformer tubes interconnected in at least a first series.

8. The apparatus according to claim 7, wherein said inlet conduit connected to said reformer tubes has at least a pre-heater coil disposed in said combustion chamber for pre-heating the steam and hydrocarbon mixture.

9. A method for steam reforming of hydrocarbons, comprising the steps of:
(i) feeding a steam and hydrocarbon mixture of a predetermined ratio to an inlet of a steam reforming apparatus;
(ii) pre-heating said steam and hydrocarbon mixture by supplying a flow of said steam and hydrocarbon mixture in at least one pre-heating conduit in a combustion chamber of said apparatus wherein combustion of at least one fuel occurs;
(iii) producing a steam reformed process gas with said steam and hydrocarbon mixture by supplying a flow of said steam and hydrocarbon mixture to a reformer tube filled with at least one catalyst and disposed in said combustion chamber to absorb heat from said combustion;
(iv) producing steam for said step (i) by recuperating heat from flue gas from said combustion, by circulating said hot flue gas through a second chamber of said apparatus in heat exchange relation with a water-containing third chamber of said apparatus.

10. The method according to claim 9, further comprising a step (v) of recuperating heat from said process gas by circulating said hot process gas through a fourth chamber of said apparatus, said fourth chamber being in heat exchange relation with said third chamber of said apparatus.

11. The method according to claim 10, wherein said fuel of said combustion includes anode off-gas recuperated from fuel cells.
